(19) United States
(12) Patent Application Publication
(10) Pub. No.: US 2015/0109825 A1
(43) Pub. Date: Apr. 23, 2015

(54) Controlling a Switched Mode Power Supply with Maximised Power Efficiency

(71) Applicants: Magnus Karlsson, Oskarshamn (SE); Oscar Persson, Kalmar (SE)

(72) Inventors: Magnus Karlsson, Oskarshamn (SE); Oscar Persson, Kalmar (SE)

(73) Assignee: TELEFONAKTIEBOLAGET L M ERICSSON (PUBL), Stockholm (SE)

(21) Appl. No.: 14/395,323

(22) PCT Filed: Apr. 20, 2012
(86) PCT No.: PCT/EP2012/057280

§ 371 Date: Oct. 17, 2014

(51) Int. Cl. H02M 3/335

(52) U.S. Cl. CPC H02M 3/33546
USPC 363/17

(57) ABSTRACT

A control circuit (200) operable to generate a control signal (D) to control the duty cycle of a switched mode power supply (100). The control circuit (200) comprises a reference signal generator (210) operable to receive a signal indicative of an input voltage (Vᵢₙ) of the switched mode power supply (100) and generate a reference signal (V_{R}) that is a function of the input voltage (Vᵢₙ), and an offset reference signal generator (220) operable to generate an offset reference signal (V_{R}_{_{—}}_{offset}) “by’ combining the reference signal (V_{R}) with an offset signal (V_{offset}), the offset signal (V_{offset}) being independent of the input voltage (Vᵢₙ), The control circuit (200) further comprises an error signal, generator (230) arranged to receive a signal indicative of an output voltage (Vₒᵤₜ) of the switched mode power supply (100) and operable to generate an error signal (V_{E}) based on the offset reference signal (V_{R}_{_{—}}_{offset}) and based on the output voltage (Vₒᵤₜ). The control circuit (200) also includes a duty cycle control signal generator (250) operable to generate the control signal (D) to control the duty cycle of the switched mode power supply (100) in dependence upon the error signal (V_{E}),

### TECHNICAL FIELD

The present invention generally relates to the field of switched mode power supplies (sometimes referred to as switch mode power supplies or switching mode power supplies) and more specifically to the control of the duty cycle of a switched mode power supply.

### BACKGROUND

The switched mode power supply (SMPS) is a well-known type of power converter having a diverse range of applications by virtue of its small size and weight and high efficiency. For example, SMPSs are widely used in personal computers and portable electronic devices such as cell phones. An SMPS achieves these advantages by switching a switching element such as a power MOSFET at a high frequency (usually tens to hundreds of kHz), with the frequency or duty cycle of the switching defining the efficiency with which an input voltage is converted to a desired output voltage.

In most SMPS topologies, the output voltage, Vₒᵤₜ, is directly proportional to the input voltage, Vᵢₙ:

Vₒᵤₜ∝nDVᵢₙ Equation 1

In Equation 1 above, D is the duty cycle of the switching, and n=nₛ/nₚ is the transformer ratio (the number of turns on the secondary side, nₛ, divided by the number of turns on the primary side, nₚ) if a transformer is used in the SMPS or n=1 if no transformer is used. The duty cycle is critical to achieving high converter efficiency, and a duty cycle of 100% will generally yield the maximum efficiency.

A number of different control strategies for controlling the duty cycle of an SMPS are known.

One method of control is used in fixed ratio converters or Intermediate Bus Converters (IBCs), which are also referred to as unregulated converters. These lack all control of the output voltage but run with a maximised duty cycle. This yields maximised power efficiency since the converter transfers energy almost 100% of the time, with the exception of the dead time needed during switching. With this strategy, the output voltage varies with the input voltage according to Equation 1 above. Unregulated converters with different topologies are disclosed in U.S. Pat. No. 7,272,021, U.S. Pat. No. 7,858,083, U.S. Pat. No. 7,564,702 and U.S. Pat. No. 7,269,034, for example. Furthermore, narrow regulation of the voltage can be taken care of by second layer SMPSs called Point of Load (POL) regulators, this power architecture being referred to as Intermediate Bus Architecture (IBA), for example as disclosed in U.S. Pat. No. 7,787,261.

Semi-regulated converters compensate for a varying input voltage (line regulation) at the expense of a varying duty cycle, which reduces power efficiency. An example of such a converter is disclosed in U.S. Pat. No. 7,787,261. The converter load can affect the output voltage, causing it to decrease with increasing load, a phenomenon known as droop. Since the output of an SMPS has an LC filter then load transients cause the output voltage to oscillate, and only inherent parasitic resistances dampen the oscillations.

Quasi-regulated bus converters, for example as disclosed in U.S. Pat. No. 7,787,261, are line regulated in only a part of the input voltage range, while in other parts of the input voltage range they are unregulated using 100% duty cycle to maximise efficiency. This yields an increased input voltage range without increasing the output voltage range.

Output regulated converters compensate for varying load conditions and input voltage changes by feedback of the output voltage. Voltage feed forward is often added in order to reduce output voltage disturbances due to input voltage transients. This type of regulation offers the most stable output voltage at the cost of lower efficiency.

Irrespective of the control strategy used, it is preferable for the output voltage of an SMPS to remain at its desired level under all conditions. However, transients and changes of the input voltage will cause the output voltage to change almost immediately. This can introduce large changes in the output voltage of the IMPS. Typically, only the inertia in an output filter of the SMPS will decrease this effect.

All the above-described control strategies have drawbacks in terms of output voltage tolerance, transient responses and power efficiency. Furthermore, many of these variables are dependent and optimising one makes the others worse.

### SUMMARY

In view of the problems in known SMPS control strategies, the present invention aims to provide an apparatus and method for generating a control signal to control the duty cycle of an IMPS in such a way that high power efficiency is maintained, whilst improving the output voltage response to transients and other operational characteristics as compared to known strategies.

In general terms, the invention introduces load regulation into a fixed ratio converter and maximises efficiency at the same time, and an embodiment improves the damping of the oscillations on the output voltage due to input voltage transients while maintaining the duty cycle near to 100%. The scheme for controlling the duty cycle of an IMPS described herein also allows highly efficient SMPS operation to be achieved over a wide range of combinations of desired input and output voltage bands, which may be defined independently of one another by the user.

More specifically, the present invention provides a control circuit operable to generate a control signal to control the duty cycle of a switched mode power supply. The control circuit comprises a reference signal generator operable to receive a signal indicative of an input voltage of the switched mode power supply and generate a reference signal that is a function of the input voltage, and an offset reference signal generator operable to generate an offset reference signal by combining the reference signal with an offset signal, the offset signal being independent of the input voltage. The control circuit further comprises an error signal generator arranged to receive a signal indicative of an output voltage of the switched mode power supply and operable to generate an error signal based or the offset reference signal and based on the output voltage. The control circuit also includes a duty cycle control signal generator operable to generate the control signal to control the duty cycle of the switched mode power supply in dependence upon the error signal.

The present invention also provides a method of generating a control signal to control the duty cycle of a switched mode power supply. The method comprises receiving a signal indicative of an input voltage of the switched mode power supply, and receiving a signal indicative of an output voltage of the switched mode power supply. The method further comprises generating a reference signal that is a function of the input voltage. An offset reference signal is generated by combining the reference signal with an offset signal, the offset signal being independent of the input voltage. An error signal is generated based on the offset reference signal and based on the output voltage. The control signal to control the duty cycle of the switched mode power supply is then generated in dependence upon the error signal.

### BRIEF DESCRIPTION OF THE DRAWINGS

Embodiments of the invention will now be described, by way of example only, with reference to the accompanying drawings in which:

FIG. 1 is a block diagram of a switched mode power supply and a control circuit according to a first embodiment of the present invention, for generating a control signal for controlling the switched mode power supply;

FIG. 2 is a block diagram showing further detail of the control circuit according to he first embodiment of the present invention;

FIG. 3 is a flowchart showing the processes performed by the control circuit of the first embodiment of the present invention;

FIG. 4 is a block diagram showing yet further detail of the control circuit according to the first embodiment of the present invention;

FIG. 5 illustrates the variation of the SMPS output voltage as a function of the input voltage;

FIG. 6 illustrates the variation of the SMPS output voltage as a function of the input voltage for two exemplary fixed transformer ratios, together with a variation generated by an offset reference signal generator according of an embodiment of the present invention;

FIG. 7 is a circuit diagram showing the interconnection of the control circuit of the first embodiment with an SMPS, so that the control circuit can control the duty cycle of the SMPS;

FIG. 8 is a timing diagram showing control signals, produced in the control circuit of FIG. 7, for switching elements in the SMPS;

FIG. 9 shows a control circuit according to a second embodiment of the invention;

FIG. 10 illustrates the variation of the SMPS output voltage as a function of the SMPS input voltage in the second embodiment of the present invention;

FIG. 11 is another schematic illustrating the variation of the SMPS output voltage as a function of the input voltage, which shows how the ability of the offset reference signal generator of the second embodiment to switch between the first and second operational modes allows a higher transformer ratio to be used in the SMPS;

FIG. 12 is a schematic illustrating how the power output of the SMPS varies with input voltage, and shows how the ability of the offset reference signal generator of the second embodiment to switch between the first and second operational modes increases the power output of the SMPS;

FIG. 13 is a schematic illustrating how the ripple current in the output choke of the SMPS varies with input voltage when the SMPS is controlled by a control circuit according to the second embodiment of the present invention;

FIG. 14 is a circuit diagram showing the interconnection of the control circuit of the second embodiment with an SMPS, so that the control circuit can control the duty cycle of the SMPS;

FIG. 15 shows a conventional DC-DC SMPS which was used in a test comparison against embodiments of the present invention;

FIG. 16 shows experimental results from the test comparison comparing the performance of the first embodiment of the present invention with the known unregulated converter for the case of an input voltage step from 38 V to 55 V with a load current of 0 A;

FIG. 17 shows experimental results from the test comparison comparing the performance of the first embodiment of the present invention with the known unregulated converter for the case of an input voltage step from 38 V to 55 V with a load current of 0 A but with the embodiment controlling the SMPS to have a load regulated supply with a minimum duty cycle;

FIG. 18 shows experimental results from the test comparison comparing the performance of the first embodiment of the present invention with the known unregulated converter for the case of an input voltage step from 38 V to 55 V with a load current of 33 A;

FIG. 19 shows experimental results from the test comparison comparing the performance of the first embodiment of the present invention with the known unregulated converter for the case of an input voltage step from 55 V to 38 V with a load current of 0 A;

FIG. 20 shows experimental results from the test comparison comparing the performance of the first embodiment of the present invention with the known unregulated converter for the case of a positive load step from 0 A to 33 A at an input voltage of 38 V;

FIG. 21 shows experimental results from the test comparison comparing the performance of the first embodiment of the present invention with the known unregulated converter for the case of a negative load step from 33 A to 0 A at an input voltage of 38 V;

FIG. 22 shows experimental results from a test comparison comparing the performance of the second embodiment of the present invention with the known converter as well as for a modification of the embodiment in which the converter operates in the second operational mode only, for the case of an input voltage step from 55 V to 38 V; and

FIG. 23 shows a modification to the control circuit of the first embodiment with the inclusion of droop processing.

### DETAILED DESCRIPTION OF EMBODIMENTS

As will be explained in detail below, an embodiment of the present invention provides a control circuit for a switched mode power supply that maintains high power efficiency and still improves the output voltage response when faced with input voltage transients or load current transients at the output. The control circuit uses a reference signal generator to generate a reference signal that is a function of the input voltage, and an offset reference signal generator to generate an offset reference signal by combining the reference signal with an offset signal, the offset being independent of the input voltage. Control of the duty cycle of the SMPS on the basis of the offset reference signal causes the SMPS to operate effectively as if is has a variable transformer turns ratio that varies with the input voltage. As will be explained in the following, the offsetting of this reference voltage allows highly efficient SMPS operation to be achieved over a wide range of combinations of desired input and output voltage bands that may be defined independently of one another by the user, thereby improving the usability of the SMPS across a wide range of applications.

### First Embodiment

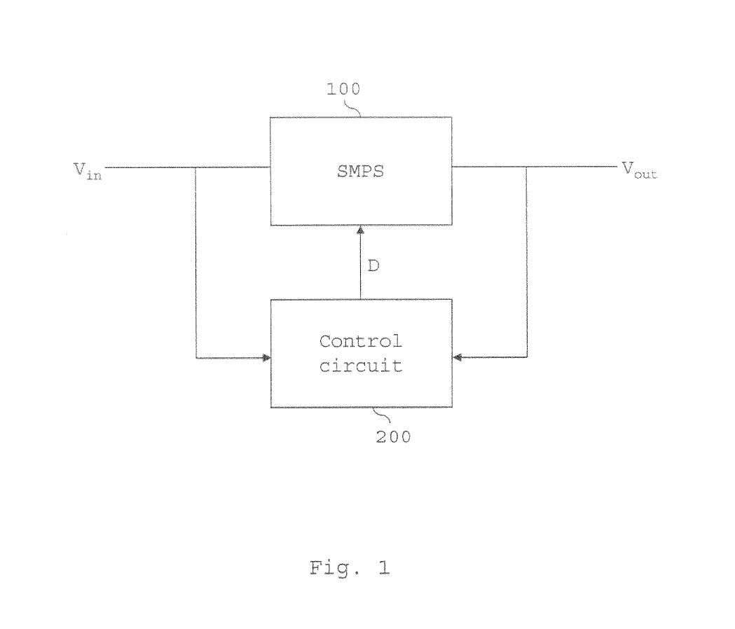

FIG. 1 depicts a top-level block diagram of a switched mode power supply (SMPS) 100 and control circuit 200. The control circuit 200 is arranged to receive signals indicative of the input voltage Vᵢₙ and the output voltage Vₒᵤₜ of the SMPS 100. These signals may comprise analogue signals of the voltages themselves or digital signals containing information defining voltage values measured by measurement equipment (not shown). Based on the signals indicative of the SMPS input voltage and the signals indicative of the output SMPS voltage, the control circuit 200 is operable to generate a control signal D to control the duty cycle of the SMPS 100. It will be appreciated that the control circuit 200 can be made and sold separately from the SMPS 100.

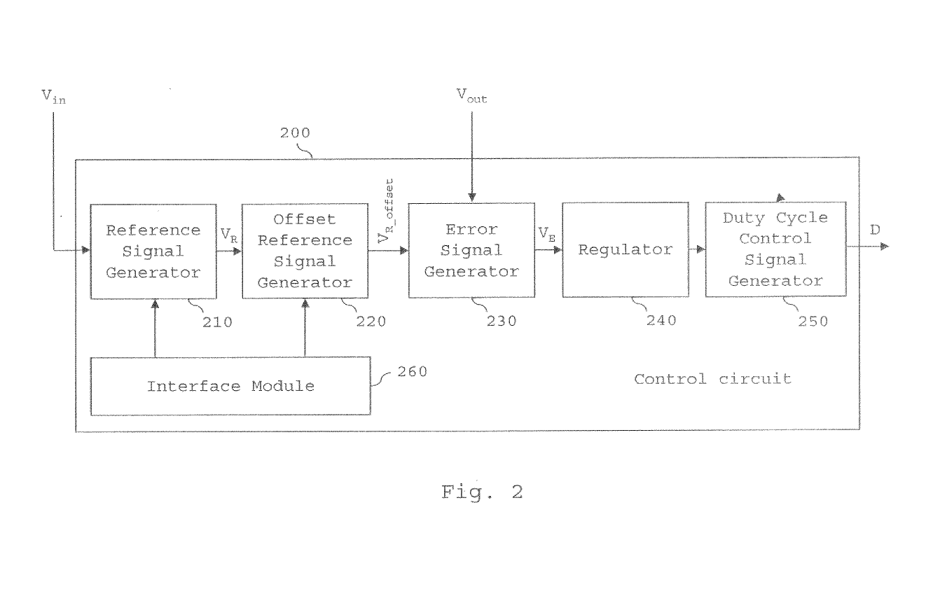

FIG. 2 is a schematic block diagram of the control circuit 200. The control circuit 200 comprises a reference signal generator 210, an offset reference signal generator 220, an error signal generator 230, optionally a regulator 240, a duty cycle control signal generator 250, and optionally an interface module 260 via which settings of the reference signal generator 210 and offset reference signal generator 220 may be adjusted as described below.

The reference signal generator 210 is arranged to receive a signal indicative of an input voltage Vᵢₙ of the SMPS 100 and operable to generate a variable reference signal V_{R} which is dependent upon the input voltage Vᵢₙ. More particularly, the reference signal generator 210 is arranged to generate the reference signal V_{R} as a function of the input voltage Vᵢₙ. This function, herein denoted f(Vᵢₙ), can be changed by the reference signal generator 210 according to user instructions that may be communicated via the interface module 260.

The offset reference signal generator 220 is operable to generate an offset reference signal, V_{R}_{_{—}}_{offset}, by combining the reference signal V_{R} generated by the reference signal generator 210 with an offset signal, V_{offset}, the offset signal V_{offset} being independent of the input voltage Vᵢₙ.

It should be noted that the functions of the reference signal generator 210 and the offset reference signal generator 220 may be combined into a single component of the control circuit 200, which generates, in a single step, an offset reference signal V_{R}_{_{—}}_{offset} in the form of a voltage that is offset in relation to the input voltage Vᵢₙ, the size of the offset independent of Vᵢₙ.

The error signal generator 230 is arranged to receive a signal indicative of the output voltage Vₒᵤₜ of the SMPS 100, as well as the offset reference signal V_{R}_{_{—}}_{offset} generated by the offset reference signal generator 220. The error signal generator 230 is operable to generate an error signal V_{E} based on the offset reference signal V_{R}_{_{—}}_{offset} and based on the output voltage Vₒᵤₜ. For comparison, in a conventional fully-regulated converter, the control circuit measures the output voltage Vₒᵤₜ of the SMPS and this is then compared with a constant reference signal that is set to yield a desired output voltage.

The error signal V_{E} is then fed into an optional regulator 240 or, if the regulator 240 is not provided, the error signal V_{E} is fed into the duty cycle control signal generator 250. The regulator 240 may be provided to generate, in dependence upon the error signal V_{E}, a signal that defines a duty cycle ratio.

The duty cycle control signal generator 250 is arranged to receive the output of the regulator 240 (or the error signal V_{F} if the regulator is not provided) and is operable to generate the required control signal D to control the duty cycle of the SMPS 100.

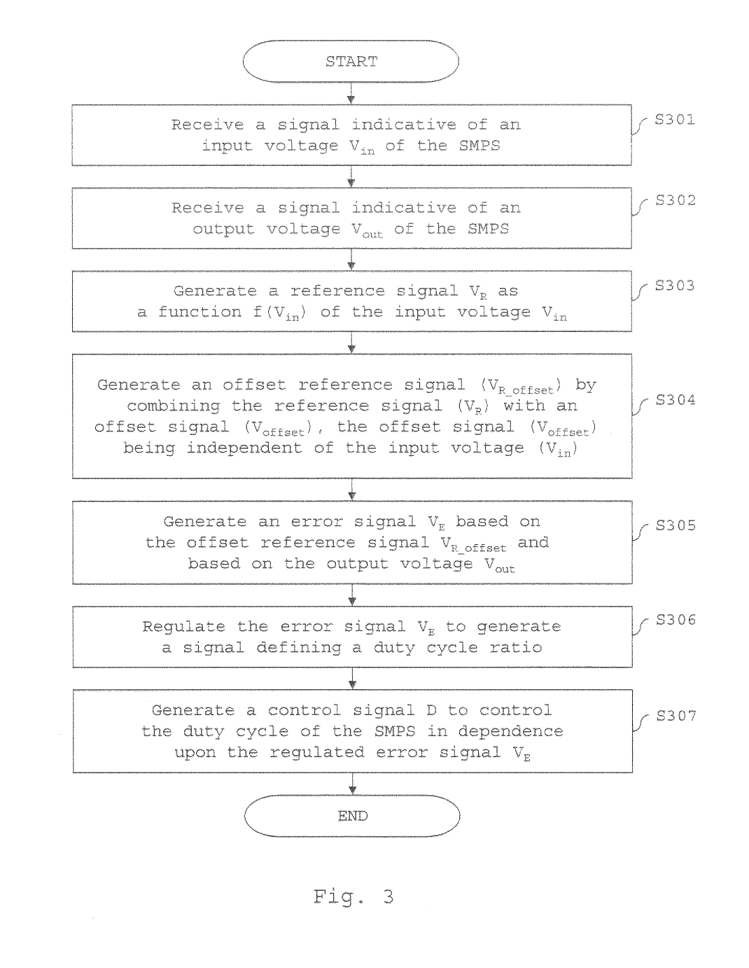

FIG. 3 is a flow chart showing the processing operations performed by the control circuit 200 of FIG. 2 for generating a control signal D to control the duty cycle of the SMPS 100.

Referring to FIG. 3, in step S301, the reference signal generator 210 receives signal indicative of an input voltage Vᵢₙ from the SMPS 100. The received signal may be an analogue representation of the input voltage Vᵢₙ of the SMPS 100 or it may be a digital representation.

At step S302, the error signal generator 230 receives a signal indicative of the output voltage Vₒᵤₜ of the SMPS 100. The received signal may similarly be an analogue representation of the output voltage Vₒᵤₜ of the SMPS 100 or it may be a digital representation thereof.

At step S303, the reference signal generator 210 generates a variable reference signal V_{R} as a function of the input voltage Vᵢₙ. The function, f(Vᵢₙ) may, for example, be a linear function, with the reference signal generator 210 generating the variable reference signal V_{R} by multiplying the received signal (which is indicative of the input voltage Vᵢₙ) by a scaling factor. The function f(Vᵢₙ) may alternatively be a non-linear function of the received signal, e.g. a quadratic or a higher-order polynomial function, and it may have one or more discontinuities. The function f(Vᵢₙ) may also be defined piece-wise for two or more working regions of the input voltage Vᵢₙ. In general, the reference signal generator 210 generates the reference signal V_{R} in step S303 as any function of the input voltage Vᵢₙ which is such that the reference signal V_{R} is zero when the input voltage Vᵢₙ is zero (in other words, a function whose plot passes through the origin).

At step S304, the offset reference signal generator 220 generates an offset reference signal V_{R}_{_{—}}_{offset} by combining the reference signal V_{R} generated at step S303 with an offset signal, V_{offset}. As noted above, the offset signal V_{offset} is not dependent on the input voltage Vᵢₙ and may be generated by the offset reference signal generator 220 itself, as in the present embodiment, or it may be generated externally of the control circuit 200 and received by the offset reference signal generator 220. In either case, the offset reference signal generator 220 combines the reference signal V_{R} with the offset signal V_{offset}, for example by adding these signals together, as in the present embodiment. As noted above, the functions of the reference signal generator 210 and the offset reference signal generator 220 may be combined into a single component of the control circuit 200, which generates, in a single step, an offset reference signal V_{R}_{_{—}}_{offset} in the form of a voltage that is offset in relation to the input voltage Vᵢₙ, the size of the offset being independent of Vᵢₙ. In this case, steps S303 and S304 are combined as a single step.

At step S305, the error signal generator 230 generates an error signal V_{R} based on both the offset reference signal V_{R}_{_{—}}_{offset} and the output voltage Vₒᵤₜ.

Optionally, the process may then proceed with step S306, at which the regulator 240 regulates the error signal V_{E} to generate a signal defining a duty cycle ratio.

At step S307, the duty cycle control signal generator 250 generates a control signal D to control the duty cycle of the SMPS 100. The generated control signal D is dependent upon the error signal V_{E} and, if the regulation step of S306 is performed, then the control signal D is generated in dependence upon the signal defining a duty cycle ratio.

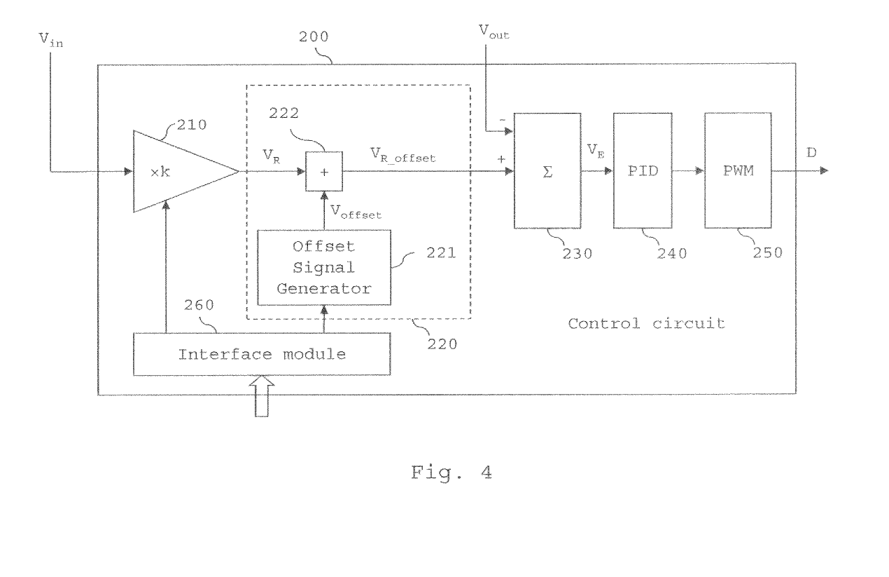

Further details of the operation of the control circuit 200 will now be described with reference to FIG. 4, which shows exemplary forms which the components shown in FIG. 2 may take. In particular, FIG. 4 illustrates an exemplary configuration of the offset reference signal generator 220 that enables it to generate an offset reference signal, as well as exemplary implementations of the reference signal generator 210, error signal generator 230, regulator 240 and duty cycle control signal generator 250.

As shown in FIG. 4, the reference signal generator 210 is configured to implement a multiplication function, specifically to multiply the received signal indicative of the SMPS input voltage Vᵢₙ (which is referred to herein and labelled in the figures as Vᵢₙ) by a scaling factor k, which may be set equal to the product of a transformer turns ratio n (where n=nₛ/nₚ and nₛ is the number of turns on the secondary side winding of the transformer, and nₚ is the number of turns on the primary side winding of the transformer) and a nominal duty cycle ratio, Dₙₒₘ, of the SMPS 100. It should be noted that if the SMPS 100 does not have a transformer, then n is set equal to unity.

Therefore, the variable reference signal V_{R} is generated by multiplying the input voltage Vᵢₙ of the SMPS 100 by the scaling to k, in accordance with the following equation.

V_{R}=kVᵢₙ Equation 2

Moreover, in the present embodiment, the reference signal generator 210 is configured to allow the scaling factor k to be set by the user. More particularly, the reference signal generator 210 is configured to receive from the interface module 260 a signal indicative of an input from the user, which may be provided by the user entering his selection, adjustment or setting of the scaling factor k via an input device such as a key pad or touch screen. The reference signal generator 210 is arranged to set the factor k in dependence upon the received signal that is indicative of the user's input. However, it should be noted that, more generally, the reference signal generator 210 may be arranged to set, in dependence upon the received signal, one or more parameters of the above-mentioned function f(Vᵢₙ) which relates the reference signal V_{R} to the input voltage Vᵢₙ, which function need not be linear in Vᵢₙ.

As shown in FIG. 4, in the present embodiment, the offset reference signal generator 220 comprises an offset signal generator 221 operable to generate a variable offset signal V_{offset}, and an adder 222 which is arranged to add the reference signal V_{R} and the variable offset signal V_{offset} received thereby, and output the result of summing these signals to the error signal generator 230 as an offset reference signal V_{R}_{_{—}}_{offset}.

In more detail, the offset signal generator 221 is arranged to receive a signal from the interface module 260 and to generate the variable offset signal V_{offset} using the received signal, for example by amplifying and/or filtering, or otherwise processing the received signal. Thus, the offset signal V_{offset} is a function of the received signal, although it is independent of the SMPS input voltage Vᵢₙ. Depending on the requirements of the specific SMPS implementation, the offset signal generator 221 may alternatively be configured to relay the signal received from the interface module 260 (or directly from a signal source external to the control circuit 200) to the adder 222 without processing it.

More specifically, in the present embodiment, the offset signal generator 221 is arranged to receive a signal indicative of an input from a user via the interface module 260, and to generate the offset signal V_{offset} in dependence on the signal that is indicative of the user's input. For example, the interface module 260 may be configured to provide an interface between the control circuit 200 and an input device such as a key pad or touch screen, via which the user can enter an amount of voltage offset which the offset signal generator 221 is to generate during operation of the control circuit 200.

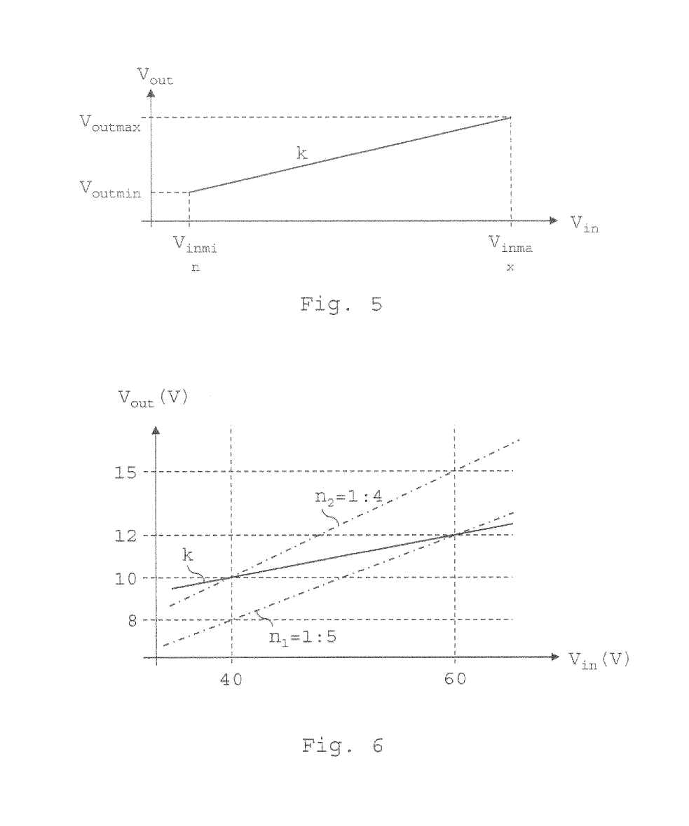

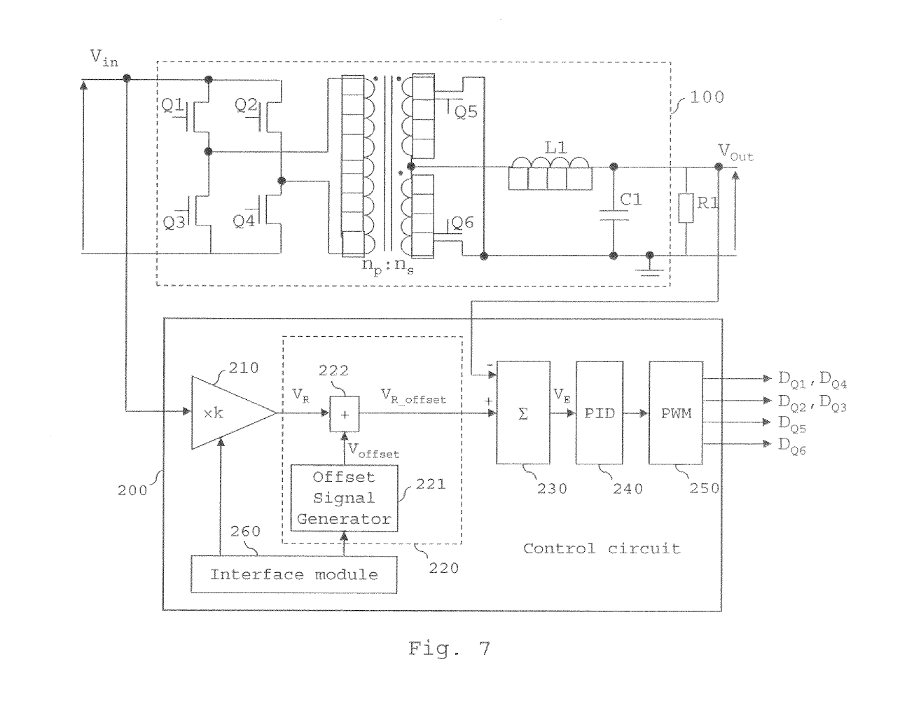

The usefulness of the user being able to specify the amount of voltage offset to be applied will now be explained with reference to FIGS. 5 and 6.

FIG. 5 illustrates a linear variation of the SMPS output voltage Vₒᵤₜ as a function of the input voltage Vᵢₙ. The gradient k of the line shown in FIG. 5 is given by (Vₒᵤₜₘₐₓ−Vₒᵤₜₘᵢₙ)/(Vᵢₙₘₐₓ−Vᵢₙₘᵢₙ), where Vₒᵤₜₘₐₓ, Vₒᵤₜₘᵢₙ, Vᵢₙₘₐₓ and Vᵢₙₘᵢₙ define the ends of the input and output voltage ranges of the SMPS 100, as illustrated. By the user being able to choose the value of k (either by making the value of k adjustable in the manner described above, or by configuring the reference signal generator 210 at the time of manufacture to perform its operation using a particular value of k), the SMPS can be made to simulate a transformer turns ratio that is different to the one actually present in the transformer of the SMPS 100. In addition, by adding an offset to the reference voltage, the user is able to set no the SMPS 100 to operate with the desired voltage conversion characteristic across any desired range of voltages. Thus, the offset reference signal V_{R}_{_{—}}_{offset}, obtained by combining the offset signal V_{offset} with the reference signal V_{R} generated by the reference signal generator 210, may be expressed more generally as follows:

V_{R}_{_{—}}_{offset}=kVᵢₙ+V_{offset} Equation 3

The ability to define any desired linear relation between the offset reference signal V_{R}_{_{—}}_{offset} and the input voltage Vᵢₙ allows the user to secure the advantages of achieving higher output voltages at lower input voltage values whilst limiting the size of the output voltage at higher input voltage values. Thus, is becomes possible to obtain an increased output power level, or a lower output current, at lower input voltages. In other words, by being able to adjust the offset signal V_{offset}, the user is able to adjust the control circuit 200 to control the SMPS 100 to operate across desired voltage ranges as if it had an input voltage-dependent transformer turns ratio. The usefulness of being able to makes these adjustments will now be explained by way of a design example.

The SMPS of the design example is a DC-DC step-down converter which has an input voltage range of 40-60 V and a desired output voltage range of 10-12 V. Using fixed transformer ratios of n₁=1:5 and n₂=1.4 yields the dashed lines shown in FIG. 6. As is evident from these plots in FIG. 6, neither of the fixed transformer ratios n₁ and n₂ allows the converter to output voltages in the desired range of 10-12 V for input voltages between 40 and 60 V.

However voltage conversion within the desired voltage ranges may be achieved by setting k and the offset voltage V_{offset} to appropriate values. More specifically, the value of k may be set according to k=(Vₒᵤₜₘₐₓ−Vₒᵤₜₘᵢₙ)/(Vᵢₙₘₐₓ−Vᵢₙₘᵢₙ), which in the present example yields k=(12−10)/(60−40)=0.1. The offset voltage, on the other hand, is given by the following expression:

$${V}_{offset} = \frac{( {V}_{in max} {V}_{out min} - {V}_{out max} - {V}_{in min} )}{( {V}_{in max} - {V}_{in min} )} \qquad Equation 4$$

In the present design example, V_{offset} is calculated according to Eqn. 4 to be 6 V.

The transformer turns ratio nₛ:nₚ to be used in the transformer of the design example is required to satisfy the following condition:

$$\frac{{n}_{s}}{{n}_{p}} > k \qquad Equation 5$$

Thus, in the present design example, the transformer turns ratio is required to be greater than 0.1.

In order to maintain efficient and stable operation when the temperature of the SMPS 100 changes, the offset signal generator 221 may additionally or alternatively be arranged to receive a signal indicative of a measured temperature of a component (e.g. the transformer) of the SMPS 100 via the interface module 260, and generate the offset signal V_{offset} in dependence upon the received signal that is indicative of the measured temperature.

Alternatively, the offset signal generator 221 of the present embodiment may additionally or alternatively be arranged to receive via the interface module 260 a signal indicative of an output load of the SMPS 100, and to generate the offset signal V_{offset} in dependence upon the received signal that is indicative of the output load. The provision of such a load-dependent offset would advantageously allow the output voltage Vₒᵤₜ of the SMPS 100 to be tuneable so as to reduce transmission losses between the SMPS 100 and its load. For example, in a so-called “Intermediate Bus Architecture” (IBA) power system in which the SMPS 100 constitutes an intermediate bus converter (IBC) that converts a system input voltage to an intermediate bus voltage (IBV) that is applied to an intermediate bus which connects the IBC to one or more point-of-load (POL) regulators, the offset signal generator 221 could receive a signal indicative of the current and voltage output by the IBC to the POL regulator(s), and adjust the IBV so as to optimize the system efficiency for the prevailing load level. The reader is referred to WO2012/007055 for further details of this scheme for optimizing the efficiency of an IBA power system.

Referring again to FIG. 4, the error signal generator 230 in this embodiment takes the form of a difference calculator, which compares the generated offset reference signal V_{R}_{_{—}}_{offset} with a signal indicative of the output voltage Vₒᵤₜ of the SMPS 100. To achieve this, in this embodiment, the difference is found between the output voltage Vₒᵤₜ and the offset reference signal V_{R}_{_{−}}_{offset} to generate the error signal V_{E}:

V_{E}=V_{R}_{_{—}}_{offset}−Vₒᵤₜ Equation 6

The error signal is then fed into a regulator 240 in the form of PID regulator. The output of the PID regulator is in a steady state and is the duty cycle required to obtain the required Vₒᵤₜ that is independent of the load current.

The output of the PID regulator 240 is then fed into the duty cycle control signal generator 250 which comprises a pulse width modulating (PWM) circuit that translates the duty cycle ratio (from the PID regulator 240) into a pulse width modulated signal D that controls the switching elements in the SMPS 100.

In summary, it will be understood from the description of the first embodiment above that the control circuit 200 introduces load regulation into an otherwise fixed ratio converter. Instead of using a fixed duty cycle, the duty cycle can be varied according to the load requirements and according to the input voltage Vᵢₙ of the SMPS 100. This is achieved using both the input voltage Vᵢₙ and the output voltage Vₒᵤₜ to generate of the duty cycle control signal D. This improves the damping of oscillations on the output due to input voltage transients, while maintaining the duty cycle near to 100%, for maximum efficiency.

In order to maintain good load regulation and transient response a design margin for the nominal duty cycle Dₙₒₘ has to be introduced. Simulations and measurements performed by the present inventors show that a margin of a few percent is enough, yielding e.g. Dₙₒₘ≈97%. Hence, the power efficiency of an embodiment is almost at maximum and not reduced much compared with a fixed radio converter, but the embodiment provides improved transient response and load regulation.

It should be noted that, because the duty cycle of an embodiment is controlled near the natural border of 100%, methods should be employed to avoid integral wind-up. For example, well-known saturation circuitry of the integral value can be used to address this issue.

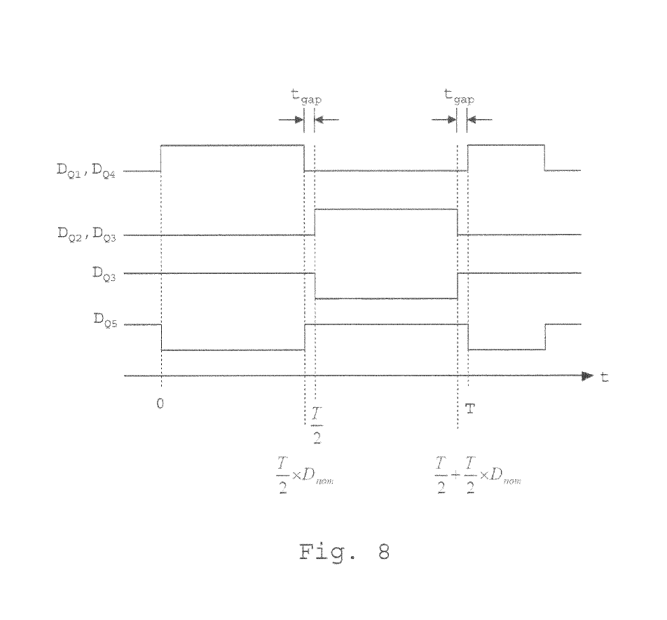

FIG. 7 depicts the integration of an SMPS 100 with the control circuit 200 described above. In this figure, a typical SMPS 100 is shown. Operation of this SMPS 100 is achieved through control of six transistors, Q1 to Q6. Running this SMPS with a maximised duty cycle of 100% will result in maximised power efficiency. This circuit is directed to a DC-DC converter, using a transformer T1. An H-bridge is provided to generate an AC signal, formed from switching elements Q1 to Q4. Specifically, Q1 and Q4 will initially be switched ON and Q2 and Q3 switched OFF. This generates a positive-swinging signal across the transformer's primary coil thereby resulting is a change in flux. As a result, a voltage is induced across the transformer's secondary coil. Q6 can then be switched ON, and Q5 switched OFF to provide rectification of the signal. Similarly, the same is performed inversely to generate a negative-swinging signal, by turning Q1, Q4 and Q6 OFF and turning Q2, Q3 and Q5 ON to capture energy from the negative portion of the cycle.

As shown in FIG. 7, and as has been described above with reference to previous figures, the control circuit 200 has inputs indicative of the input voltage Vᵢₙ and output voltage Vₒᵤₜ of the SMPS 100. Based on these inputs, the control circuit 200 generates various duty cycle control signals D for controlling the various switching elements of the switched mode power supply 100, as described below. In this case the ground reference is at the secondary side.

FIG. 8 depicts an exemplary timing diagram for the various control signals as output from the control circuit 200 to control the duty cycle of the SMPS 100. The control signals relate to the switching elements of the SMPS 100, as depicted in FIG. 7. In the following explanation of FIGS. 7 and 8, the factor k is taken to be nDₙₒₘ by way of example.

As shown in FIG. 8, the control signals for Q1 and Q4 (labelled D_{Q1} and D_{Q4}) closely match the inverse of tho control signals for Q2 and Q3 (labelled D_{Q2} and D_{Q3}). This generates alternate positive and negative voltage cycles on the primary side of the transformer T1. This induces a changing flux in the transformer T1 and thereby induces a voltage across the secondary side of the transformer T1.

The small timing gap t_{gap} between the end the control signal for Q1 and Q4 and the start of the control signal for Q2 and Q3 is due to Dₙₒₘ not being exactly 100% but instead being around 97% in the present embodiment. As a result, the length of the ‘ON-time’ for Q1 and Q4 is substantially T/2×Dₙₒₘ, where T is the length of a cycle. Similarly the ‘ON/time’ for Q2 and Q3 is also substantially T/2×Dₙₒₘ. The control circuit 200 controls the ‘ON-time’ to maintain good load regulation and transient response by controlling the size of the timing gap t_{gap}.

FIG. 8 also snows typical control signals for Q5 and Q6 (labelled D_{Q5} and D_{Q6}). As shown, at the end of the first half ‘ON period’ for Q1 and Q4, Q5 is switched ON whilst Q6 as ON. This generates a conductive path to allow the discharging of inductor L1 into capacitor C1 and the load R. After this, Q6 is switched OFF and Q5 is left ON to perform rectification of the signal from the secondary side of the transformer T1.

### Second Embodiment

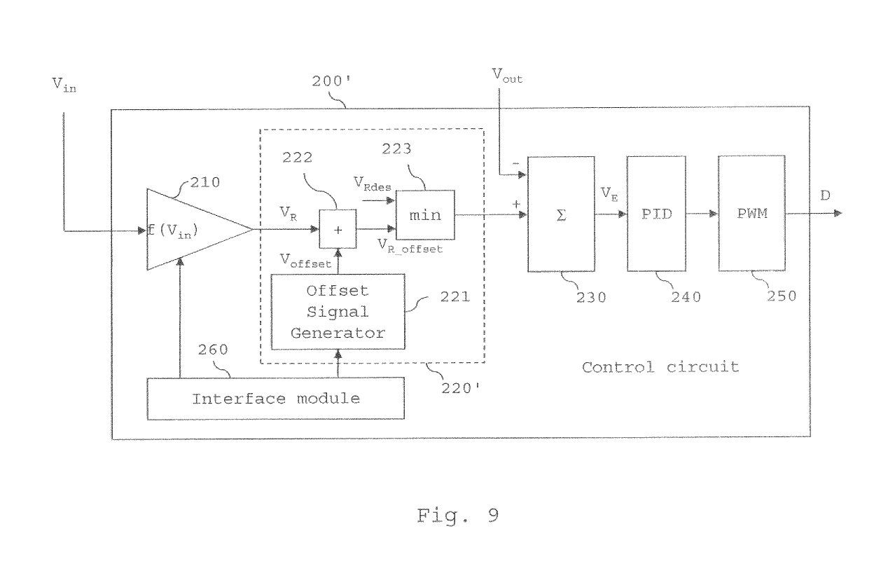

A control circuit 200′ according to a second embodiment of the present invention will now be described with reference to FIGS. 9 to 14.

As can be appreciated from a comparison of FIGS. 4 and 9, the control circuits 200 and 200′ of the first and second embodiments have many features in common, and the description of the structure and functionality of these common components will therefore not be repeated. However, the offset reference signal generator 220′ of the second embodiment differs from that of the first embodiment, and the structure and operation of this component of the control circuit 200′ will now be described in detail.

In a first mode of operation (also referred to herein as the “Regulated Ratio” mode), the offset reference signal generator 220′ is operable to function as the offset reference signal generator 220 of the above-described first embodiment. However, in contrast to the offset reference signal generator 220 of the first embodiment, the offset reference signal generator 220′ of the second embodiment is also operable in a second mode (also referred to herein as the “Fully Regulated” mode) to generate a predetermined reference signal V_{Rdes} which is set to a desired level. The size of V_{Rdes} may be set to a fixed value or may be made adjustable by the SMPS operator. Accordingly, during operation, V_{Rdes} remains constant unless changed by the operator.

As will be explained in the following, the offset reference signal generator 220′ is configured to operate in the second mode when the input voltage Vᵢₙ exceeds a threshold value, and to operate in the first mode when the input voltage Vᵢₙ equal to or smaller than the threshold value.

For comparison, in a known fully-regulated converter, which can only use a fully-regulated control strategy, the control circuit measures the output voltage Vₒᵤₜ of the SMPS 100, and this is then compared with a constant reference signal equal to the desired output voltage or directly proportional to the desired output voltage, with no provision for switching to a mode of operation which employs a variable reference voltage that is dependent upon the input voltage of the SMPS. In contrast, as explained herein, in the second embodiment of the present invention, the signal output by the offset reference signal generator 220′ is a function of the input voltage Vᵢₙ of the SMPS 100 in the first operational mode, and constant in the second operational mode of the offset reference signal generator 220′.

The operations performed by the control circuit 200′ of the second embodiment in the first mode of operation are the same as those performed by the control circuit 200 of the first embodiment. On the other hand, the conventional processing operations undertaken when the offset reference signal generator 220′ operates in the second mode of operation (i.e. Fully Regulated) are well known and will therefore not be described here.

As shown in FIG. 9, the offset reference signal generator 220′ of the second embodiment comprises a reference signal selector 223, which functions to control the switching between the first and second modes of operation of the offset reference signal generator 220′. More specifically, as shown in FIG. 9, the reference signal selector 223 is operable to receive the predetermined reference signal V_{Rdes} from e.g. a precision reference, and the offset reference signal V_{R}_{_{—}}_{offset} from the adder 222, and then select, as the reference signal to be provided to the error signal generator 230, the smaller of these received signals according to the following equation:

V_{R}=min {V_{R}_{_{—}}_{offset}, V_{Rdes}} Equation 7

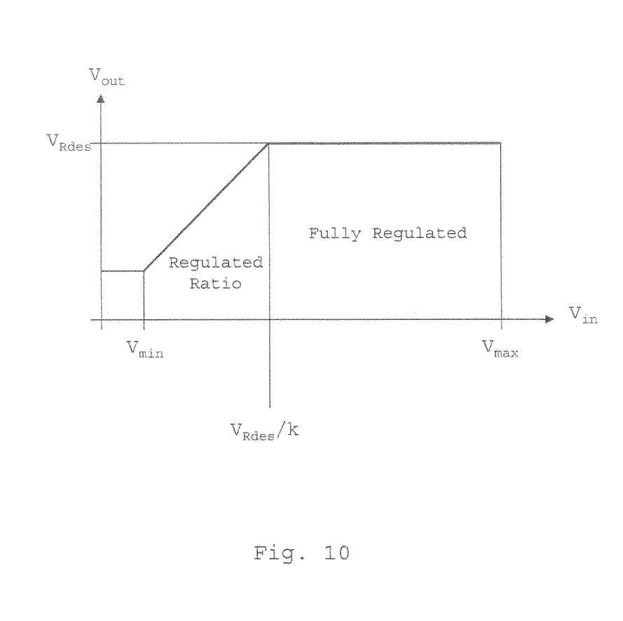

In Equation 7, “min” denotes the minimum function which selects the minimum value of the operands. The output voltage Vₒᵤₜ as a function of the input voltage Vᵢₙ is illustrated in FIG. 10.

There are significant advantages associated with the capability of the offset reference signal generator 220′ to switch from operating in one of the two above-described operational modes to the other mode, depending on the prevailing SMPS input voltage level.

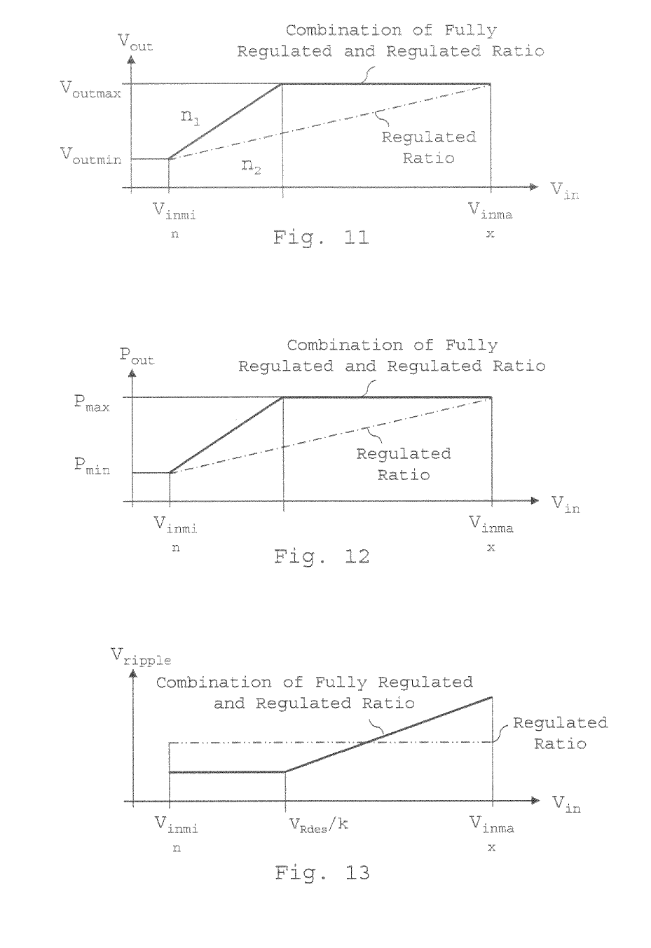

For example, as can be appreciated from the variation of the SMPS output voltage Vₒᵤₜ with the input voltage Vᵢₙ shown schematically in FIG. 11, using the above-described combination of the Fully Regulated and the Regulated Ratio modes of operation (i.e. the combination of the above-described first and second modes) allows for a higher transformer turns ratio to be used in the SMPS 100 as compared to the case where the offset reference signal generator 220′ is configured to operate in the Regulated Ratio mode only. As shown in FIG. 11, turns ratio n₁ required for the combination is greater than the turns ratio n₂ required when operation is limited to the Regulated Ratio mode.

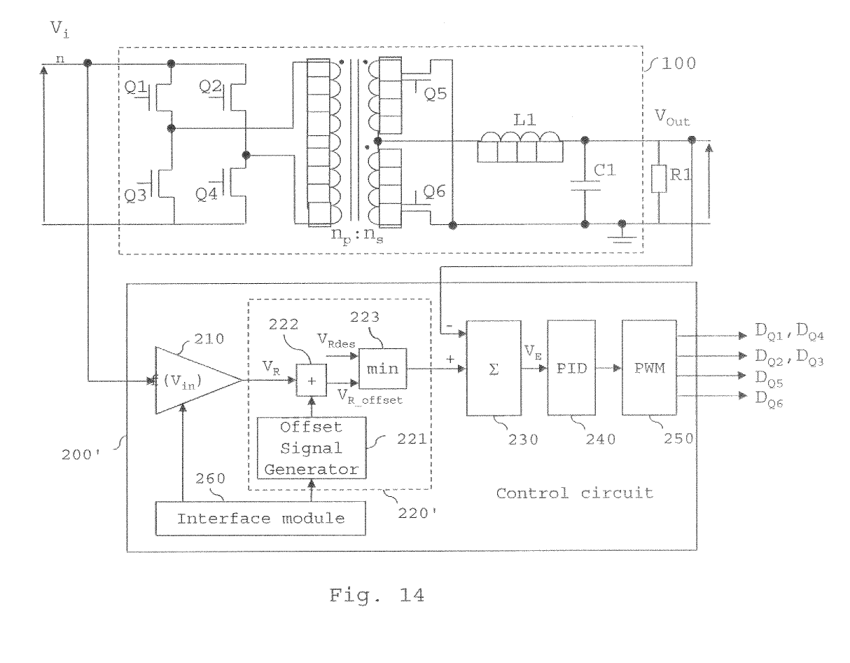

Furthermore, as illustrated in FIG. 12, where the control strategy employs the above-described combination of the Fully Regulated and the Regulated Ratio operational modes, the output voltage Vₒᵤₜ is larger in the whole working region, which allows the output power Pₒᵤₜ to be increased without increasing the output current that is the limiting factor in the design.

FIG. 13 is a schematic illustrating the variation of the SMPS output current ripple Iᵣᵢₚₚₗₑ with the input voltage Vᵢₙ. Where the offset reference signal generator 220′ operates in the Regulated Ratio mode, the output current ripple Iᵣᵢₚₚₗₑ is constant and independent of the input voltage Vᵢₙ, in contrast with the Fully Regulated part of the combination control strategy, where the current ripple Iᵣᵢₚₚₗₑ increases with input voltage Vᵢₙ. This implies that the pure Regulated Ratio can use a smaller inductor for a given ripple requirement than the combination control strategy. However, a larger inductor is preferable in terms of active current sharing.

FIG. 14 shows a power supply system comprising an SMPS 100 and a control circuit 200′ arranged to generate control signals to control the duty cycle of the SMPS 100. Except for the ability of the offset reference signal generator 220′ to switch between operating in the first and second mode, the components of the power supply system shown in FIG. 14 and their interactions are the same as those described above with reference to FIG. 7.

### Experimental Results

The inventors have performed simulation experiments to compare the performance of an SMPS 100 controlled using a control circuit according to an embodiment of the present invention with an unregulated SMPS, to show the improvement, as made by embodiments of the present invention, in terms of input voltage transient and load transient behavior.

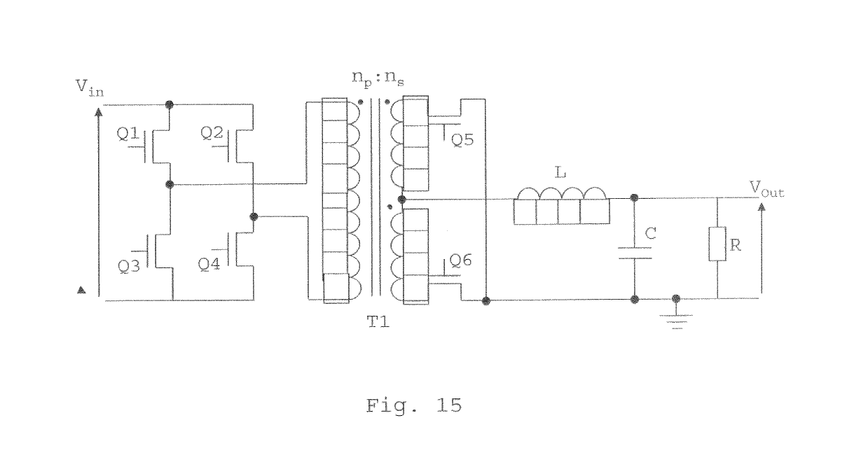

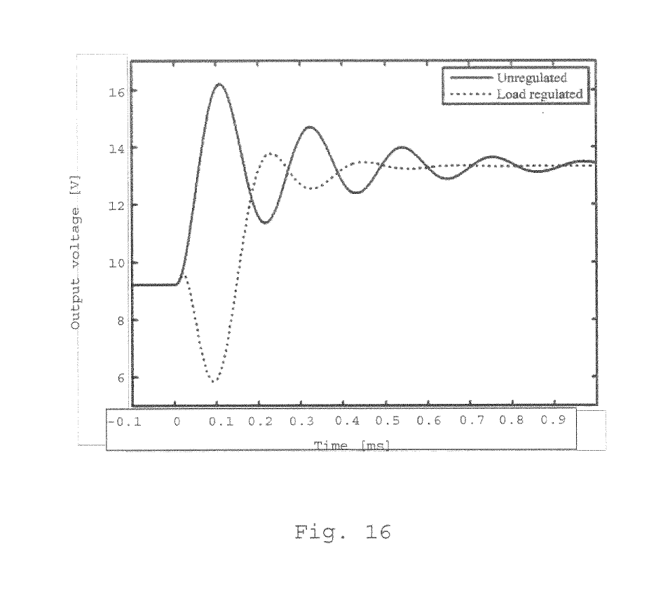

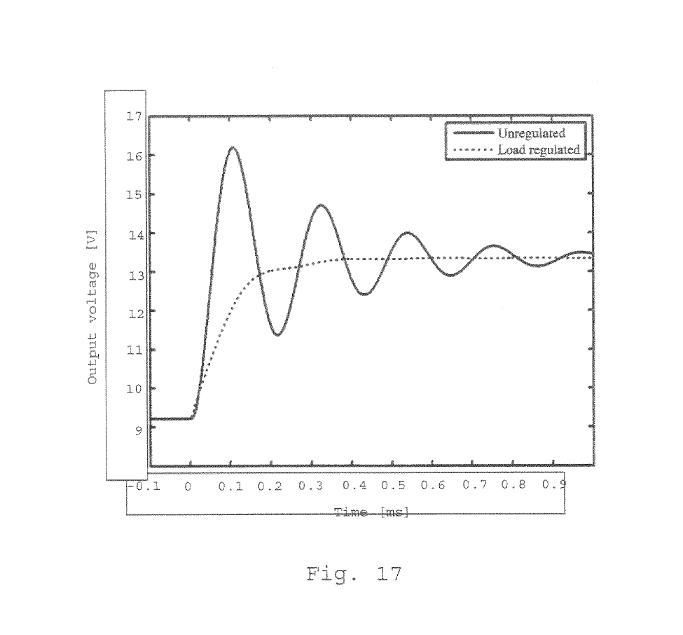

More particularly, the inventors compared the performance of the SMPS 100 and control circuit 200 shown in FIG. 7 and detailed above with the SMPS 100 shown in FIG. 15. The SMPS 100 shown in FIG. 15 is the same as the SMPS 100 shown in FIG. 7, but it is operated in an unregulated mode and therefore does not benefit from the control of the control circuit 200 of embodiments of the present invention.

In the experiments, the SMPS 100 had an input voltage range of 38-55 V and a transformer ratio of 4:1, yielding an ideal output voltage range of 9.5-13.75 V. The maximum output load current was 33 A. FIGS. 16 to 21 show the results of the experiments.

In FIG. 16, the input voltage transients of the fixed ratio (4:1) unregulated converter, and the load regulated converter controlled in accordance with the control circuit 200 according to an embodiment of the present invention are shown for a scenario in which the input voltage step raises from 38 V to 55 V with a rise time of 100 microseconds and with a load current of 0 A.

The unregulated converter shows a rapid output voltage increase with a large overshoot and large ringing with less damping compared with the load regulated converter.

The inventors have found that the voltage dip in the regulated converter is due to a delay in the measurement of the input voltage, and have further found that reducing this delay will reduce this dip.

The inventors have also found that another solution to prevent the initial dip in output voltage of the load regulated converter is to perform control using the control circuit 200 to limit the duty cycle range, so as to apply a minimum duty cycle, for example 70%. This prevents the duty cycle control signal generator 250 from outputting a control signal D with a duty cycle below 70%.

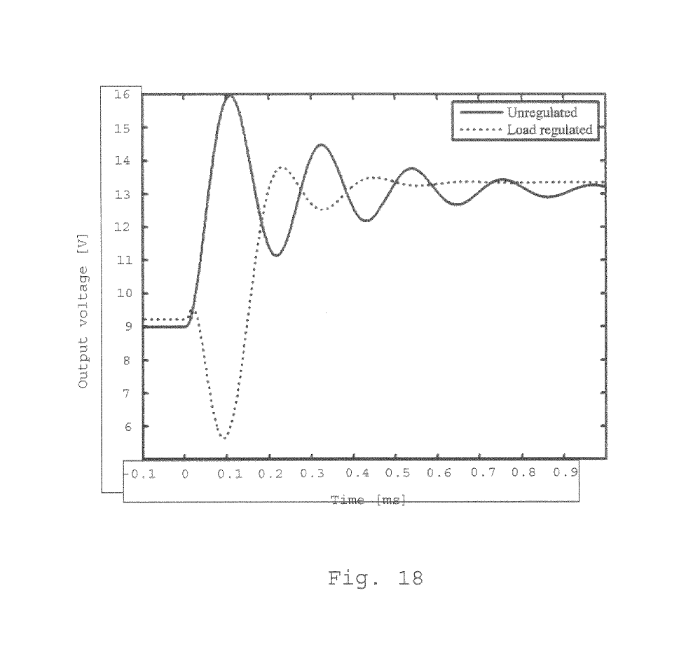

The simulation of FIG. 16 (voltage rise from 38 V to 55 V with a rise time of 100 microseconds and with a load current of 0 A) was therefore repeated applying a minimum duty cycle of 70% to the load regulated converter. The results are shown in FIG. 17. As shown in FIG. 17, the dip is removed and the damping of the oscillations is improved by applying a minimum duty cycle threshold.

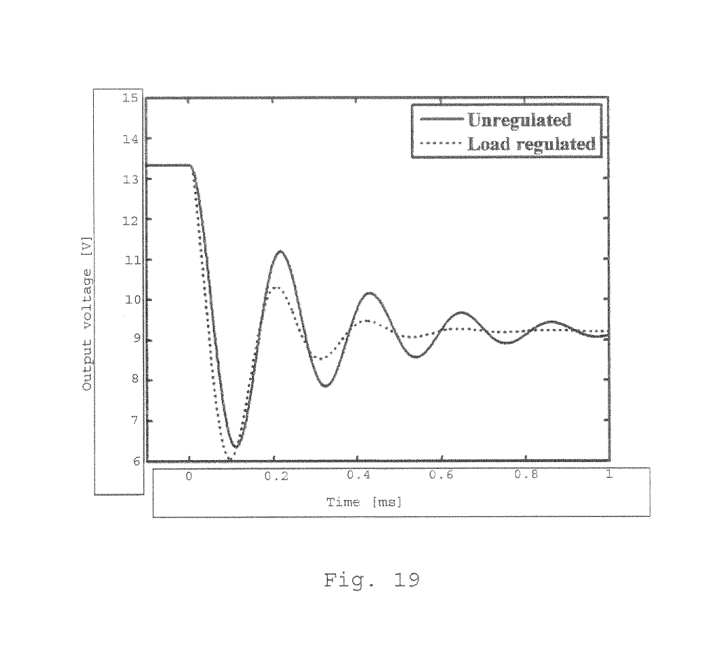

FIG. 18 shows the results of performing the same simulation as in FIG. 16 but carried out at the full load current of 33 A instead of 0 A. This illustrates the load regulation by the steady state voltage drop in the unregulated converter since the initial and final output voltages of the unregulated converter are below the ideal levels, which are exhibited by the load regulated converter.

It will also be seen that the damping of the load regulated converter is far superior to that of the unregulated converter.

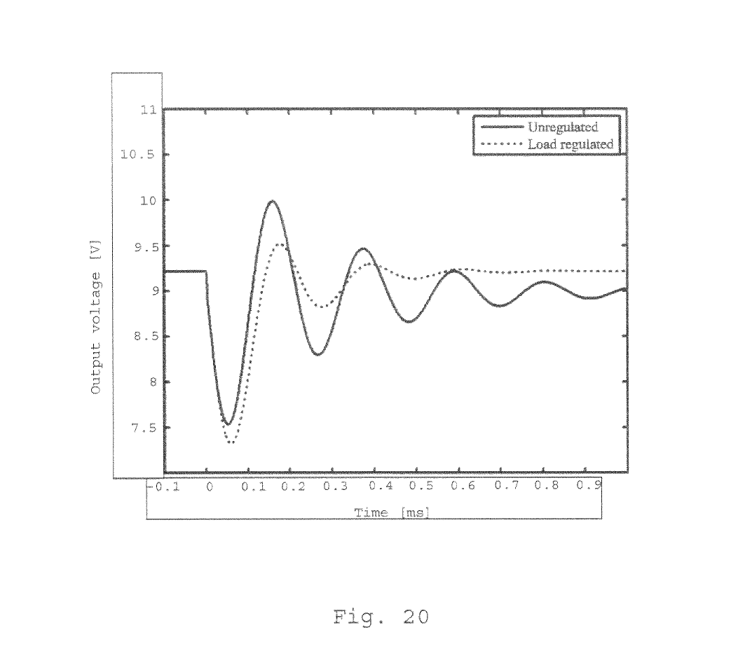

FIG. 19 shows the output voltage Vₒᵤₜ of the SMPS 100 during a negative input voltage step from 55 V down to 38 V with the load current of 0 A in 100 microseconds. It will be seen that the damping of the load regulated convertor is far superior to that of the unregulated convertor.

FIG. 20 shows the results of a positive load step from 0 A to 33 A in 1 microsecond at an input voltage of 38 V. The regulated converter has a reduced undershoot with damped oscillations, while the unregulated converter has more undershoot and much less damped oscillations. The steady state output voltage also shows the improved load regulation, i.e., the output voltage is not dependent on the load current since the final output voltage of the unregulated converter is far below the desired levels exhibited by the load regulated converter.

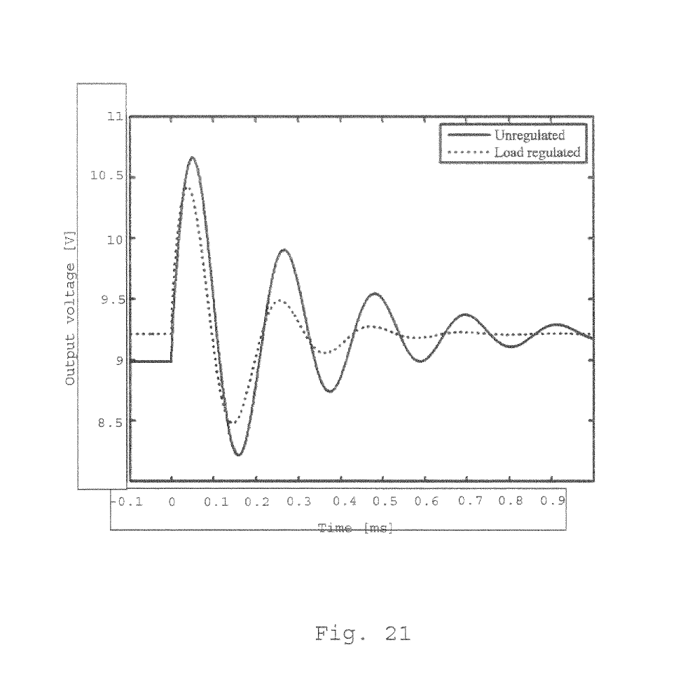

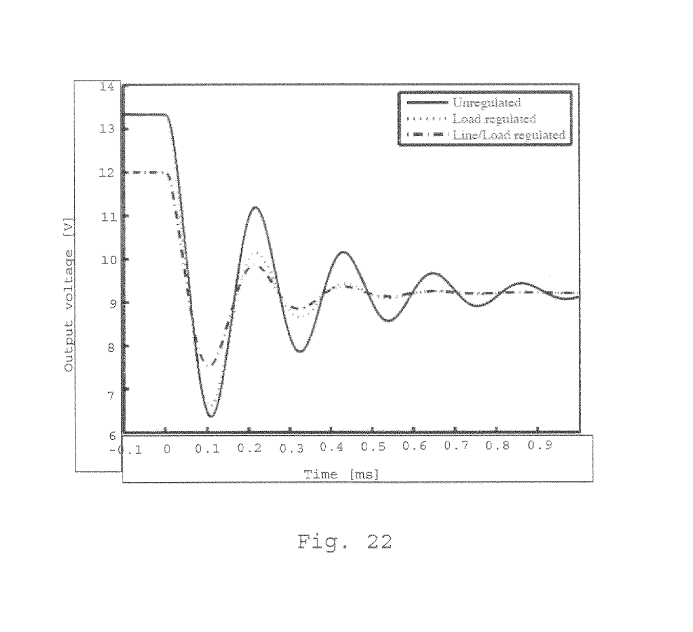

Similarly, FIG. 21 depicts a negative load step from 33 A to 0 A in 1 microsecond at the input voltage of 38 V. Again, the load regulated converter exhibits less overshoot with greater damping of the oscillations.

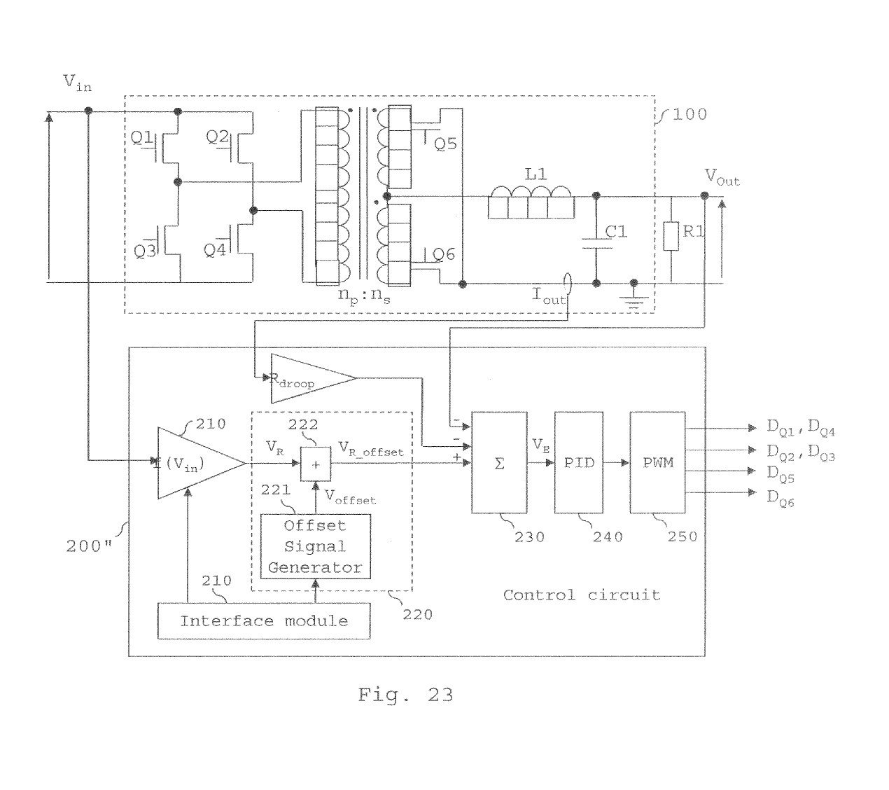

In the case where the offset reference signal generator 220′ can switch between operating in the Fully Regulated mode and the Regulated Ratio mode in accordance with the above-described second embodiment, the results of a simulation of an input voltage step from 55 V down to 38 V are shown in FIG. 22. More specifically, FIG. 22 shows a comparison of simulation results obtained when the unregulated fixed ratio, Regulated Ratio, and the combination of Regulated Ratio and Fully Regulated (i.e. line/load regulated), modes of operation are employed. In all cases, the fall time is 100 microseconds and the load current is 0 A.

In the combined Regulated Ratio, Fully Regulated case is V_{Rdes}=12 V, one can observe that the scheme clamps the output voltage to V_{Rdes}=12 V. Moreover, the damping of the oscillations is improved compared to the other two control strategies, mainly due to a smaller output range.

### Modifications and Variants

Many modifications and variations can be made to the embodiments, without departing from the scope of the present invention.

For example, although the control circuit 200, 200′ of the above described embodiments is a separate unit which provides control signals for controlling the duty cycle of the SMPS 100, the control unit 200, 200′ may instead be incorporated within the SMPS 100.

Furthermore, the control circuit 200, 200′ can be implemented using either analog or digital electronics, with no loss of performance. In a digital implementation of the control circuit 200, 200′, the reference signal generator 210, the offset reference signal generator 220, the error signal generator 230 and/or the regulator 240 may be implemented as software components of that may form at least a part of a computer program, module, object or sequence of instructions executable by a programmable signal processing apparatus such as a microprocessor.

The offset reference signal generator 220′ of the above-described second embodiment is configured to switch between its first and second modes of operation by the reference signal selector 223 selecting the smaller of reference signals V_{Rdes} and V_{R}_{_{—}}_{offset} which have been generated by a reference source and the offset reference signal generator 220, respectively. However, the switch may alternatively be performed by comparing the signal indicative of the SMPS input voltage against a threshold and then generating either V_{Rdes} or V_{R}_{_{—}}_{offset}, depending on the result of this comparison.

The regulator 240 may be of any type and not specifically a PID regulator. For example, it may be a PI, PD, or lead lag compensation regulator, or another type of regulator.

The control strategy, as detailed in the above described embodiments, could be complemented with voltage feed forward compensation.

Since the SMPS 100 may be an isolated SMPS 100, then the control circuit 200 could be placed on the primary or secondary side of the transformer T1. However, the preference is for placement on the secondary side. Depending on the placement of the control circuit 200, 200′, then one of either the output voltage Vₒᵤₜ of the SMPS 100 or the input voltage Vᵢₙ of the SMPS 100 must be transferred over the isolation barrier. There are many well-known techniques for achieving this, for example sampling of the voltage on the secondary side of the transformer T1 of the SMPS 100 during the on-period is a good measurement of the input voltage, including the transformer ratio n.

Further, the control circuit 200, 200′ is not limited to controlling the SMPS topology of a full-bridge, center-tapped secondary side transformer with synchronous rectification, as shown in FIGS. 8 and 10. Instead, the above described embodiments of the present invention will work equally well with many topologies including push-pull, half-bridge and forward converters topologies. The above-described control circuit 200 or 200′ can used with SMPSs with a single winding secondary side transformer, and it also works with SMPSs with diode rectification on the secondary side.

The inventors have found that the above-described control circuit of embodiments of the present invention works particularly well when implemented with active droop which enables passive current sharing or the paralleling of several identical SMPS converters.

FIG. 24 shows a modification of the control circuit 200 of the first embodiment which incorporates active droop. In this variant, the active droop is obtained by measuring the output current Iₒᵤₜ and then modifying the calculation of the error signal according to the following equation:

V_{E}=min {kVᵢₙ+V_{offset}, V_{Rdes}}−Vₒᵤₜ−IₒᵤₜR_{droop} Equation 8

In Equation 8 above, n=nₛ/nₚ is the transformer turns ratio if it exists in thee SMPS, Vₒᵤₜ is the output voltage of the SMPS 100, Iₒᵤₜ is the output current of the SMPS 100 and R_{droop} is the artificial droop resistance.

It will also be appreciated that the process steps illustrated in the flow chart in FIG. 3 may be executed in a different order to that shown. For instance, steps S301 and S302 in FIG. 3 may be interchanged, or step S320 may be executed after step S303.

The foregoing description of embodiments of the present invention has been presented for the purpose of illustration and description. It is not intended to be exhaustive or to limit the invention to the present form disclosed. Alternations, modifications and variations can be made without departing from the spirit and scope of the present invention.

1-19. (canceled)

20. A control circuit configured to generate a control signal to control a duty cycle of a switched mode power supply, comprising:
a reference signal generator configured to receive a signal indicative of an input voltage of the switched mode power supply and generate a reference signal that is a function of the input voltage;
an offset reference signal generator configured to generate an offset reference signal by combining the reference signal only with an offset signal that is independent of the input voltage;
an error signal generator configured to receive a signal indicative of an output voltage of the switched mode power supply and generate an error signal by subtracting one of the offset reference signal and the received signal that is indicative of the output voltage of the switched mode power supply from the other of the offset reference signal and the received signal that is indicative of the output voltage of the switched mode power supply, such that the error signal is a difference between the offset reference signal and the output voltage of the switched mode power supply; and
a duty cycle control signal generator configured to generate the control signal to control the duty cycle of the switched mode power supply based on the error signal.

21. The control circuit according to claim 20, wherein the offset reference signal generator comprises an offset signal generator configured to generate a variable offset signal.

22. The control circuit according to claim 21, wherein the offset signal generator is configured to receive a signal indicative of a measured temperature of the switched mode power supply and generate the offset signal in dependence on the measured temperature.

23. The control circuit according to claim 21, wherein the offset signal generator is configured to receive a signal indicative of an output load of the switched mode power supply and generate the offset signal based on the output load.

24. The control circuit according to claim 21, further comprising an interface between the control circuit and an input device, wherein the control circuit is configured to receive an offset amount entered by a user via the input device, and wherein the reference signal generator is configured to combine the offset amount entered by the user with the reference signal during operation of the control circuit.

25. The control circuit according to claim 20, further comprising an interface between the control circuit and an input device, and wherein the control circuit is configured to receive one or more parameters of the function which relates the reference signal to the input voltage, as entered by the user via the input device.

26. The control circuit according to claim 20, wherein the offset reference signal generator is configured in a first mode to generate the offset reference signal by combining the reference signal with the offset signal and configured in a second mode to generate a predetermined reference signal independent of the input voltage, the offset reference signal generator being configured to operate in the second mode when the input voltage exceeds a threshold value, and to operate in the first mode when the input voltage is equal to or smaller than said threshold value.

27. The control circuit according to claim 26, wherein the offset reference signal generator comprises a reference signal selector configured to select the smaller of the generated offset reference signal and the predetermined reference signal for output by the offset reference signal generator.

28. The control circuit according to claim 20, wherein the offset reference signal generator comprises an adder configured to add the offset signal to the reference signal.

29. The control circuit according to claim 20, wherein the error signal generator is configured to receive a signal indicative of an output current of the switched mode power supply and generate the error signal based on the offset reference signal, the received signal indicative of the output voltage, and the received signal indicative of the output current.

30. A switch mode power supply comprising a control circuit configured to generate a control signal to control a duty cycle of a switched mode power supply, the control circuit comprising:
a reference signal generator configured to receive a signal indicative of an input voltage of the switched mode power supply and generate a reference signal that is a function of the input voltage;
an offset reference signal generator configured to generate an offset reference signal by combining the reference signal only with an offset signal that is independent of the input voltage;
an error signal generator configured to receive a signal indicative of an output voltage of the switched mode power supply and generate an error signal by subtracting one of the offset reference signal and the received signal that is indicative of the output voltage of the switched mode power supply from the other of the offset reference signal and the received signal that is indicative of the output voltage of the switched mode power supply, such that the error signal is a difference between the offset reference signal and the output voltage of the switched mode power supply; and
a duty cycle control signal generator configured to generate the control signal to control the duty cycle of the switched mode power supply based on the error signal.

31. A method of generating a control signal to control the duty cycle of a switched mode power supply, comprising:
receiving a signal indicative of an input voltage of the switched mode power supply;
receiving a signal indicative of an output voltage of the switched mode power supply;
generating a reference signal as a function of the input voltage;
generating an offset reference signal by combining the reference signal only with an offset signal that is independent of the input voltage;
generating an error signal by subtracting one of the offset reference signal and the received signal that is indicative of the output voltage of the switched mode power supply from the other of the offset reference signal and the received signal that is indicative of the output voltage of the switched mode power supply, such that the error signal is a difference between the offset reference signal and the output voltage of the switched mode power supply; and
generating the control signal to control the duty cycle of the switched mode power supply based on the error signal.

32. The method according to claim 31, further comprising generating a variable offset signal.

33. The method according to claim 32, further comprising:
receiving a signal indicative of a measured temperature of the switched mode power supply,
wherein the offset signal is generated based on the measured temperature.

34. The method according to claim 32, further comprising:
receiving a signal indicative of an output load of the switched mode power supply,
wherein the offset signal is generated based on the output load.

35. The method according to claim 32, further comprising:
receiving a signal indicative of an input from a user,
wherein the offset signal is generated based on the received signal.

36. The method according to claim 31, further comprising:
receiving a signal indicative of an input from a user; and
changing the function which relates the reference signal to the input voltage based on the received signal.

37. The method according to claim 31, further comprising:
receiving a signal indicative of an output current of the switched mode power supply; and
generating the error signal based on the offset reference signal, the output voltage and the output current.

38. The method according to claim 31, wherein generating the offset reference signal includes adding the offset signal to the reference signal.
